(19) United States
(12) Patent Application Publication
(10) Pub. No.: US 2002/0163643 A1
(43) Pub. Date: Nov. 7, 2002

(54) Optical interference apparatus and method

(76) Inventors: Chian Chiu Li, Sunnyvale, CA (US); Daniel Chu, Fremont, CA (US)

Correspondence Address: LaRiviere, Grubman & Payne, LLP, P.O. Box 3140, Monterey, CA, 93942, US

(21) Appl. No.: 09/848,783

(22) Filed: May 4, 2001

(51) Int. Cl. H01S 3/08; G01B 9/02

(52) U.S. Cl. 356/450

(57) ABSTRACT

An optical interference device and method for creating an interference spectrum of a light wave. The device includes first optical structure for simultaneously performing wave front division and different phase retardation on the light wave to produce at least two light wave portions. The device includes a second optical structure for interfering the at least two wave portions. The second optical structure is also disposed in the light path, and facilitates creating the interference spectrum. The interference device is conducive for being configured in either a fixed wavelength or tunable wavelength configuration and may be used in optical interferometer, interferometric modulator, interferometric filter, and interferometric laser applications. The interference spectrum is tuned by varying any combination of the medium characteristics of the first and second optical structure (e.g., the index of refraction and, the distance along which the wave travels in the medium.

### FIELD OF THE INVENTION

The present invention relates to optical interference devices. More particularly, the present invention relates to tunable optical interference devices. Even more particularly, the present invention relates to tunable optical interference devices that process light waves by wavefront division and which are used in the field of optical interferometery, including the field of interferometric lasers.

### BACKGROUND OF THE INVENTION

Interference devices are key components of optical interferometers, interferometric modulators, interferometric filters, and interferometric lasers. An interferometer is an instrument typically used for high precision measurement (e.g., length, positioning, surface quality, thickness, and refractive index measurement). Among the well-known interferometers are the Rayleigh, Michelson, and Mach-Zehnder interferometers. An interferometric modulator is mainly used for modulating intensity. Intensity modulators are widely used in optical networks. A Mach-Zehnder modulator is one major type of interferometric intensity modulator. Both interferometers and conventional modulators tend to be either bulky in a free space configuration or have coupling and manufacturing difficulties in an integrated configuration. Also, an interferometric filter is typically used to select one channel, while blocking other channels in a communication system. A filter, especially a tunable filter, is a critical component in an optical network. A thin film interference filter is a widely used fixed wavelength filter requiring complex deposition technology. Fabry-Perot and Mach-Zehnder filters are the two well-known tunable filters. A Fabry-Perot tunable filter has strict requirements on reflector parallelism, which presents difficulty in manufacturing. A Mach-Zehnder tunable filter experiences similar problems as the Mach-Zehnder interferometer.

As stated above, an interferometric laser uses interference devices as a key component. An interferometric laser may be either a fixed wavelength laser or a tunable wavelength laser. A fixed wavelength laser, as well as a tunable wavelength laser, can serve as a light source in an optical network. An interferometric laser is generally configured using either a Michelson interferometer or a Mach-Zehnder interferometer. A Y-laser is a well known Mach-Zehnder interferometric laser. The Y-laser comprises two or three active sections configured in the form of a Y-shape. The Y-laser's output wavelength is tuned by current injection. Since current injection is also related to output power, control of power and wavelength is further complicated in either fixed wavelength or tunable wavelength lasers. The Y-laser, and the other type of interferometric lasers are either bulky, have complicated control, or have poor stability in a free space configuration that is due to the quantity of beam-splitters and reflectors required to perform the task.

Interference devices are based on optical interference principles. These principles include two types of optical interference, namely interference by amplitude division and interference by wave front division. Processing light waves by wave front division means that portions of the primary wave front are used either directly as sources to emit secondary waves or in conjunction with optical devices to produce virtual sources of secondary waves. (Ref: Hecht, Eugene, Optics, Chapter 9, page 334 (1987)).

A Rayleigh interferometer is representative of conventional interference apparatuses that processes light waves by wave front division. FIG. 1A illustrates a two-step configuration of a Rayleigh interferometer where in a first step, a light wave 102 is transformed into two waves by two slits 10. Each of the split waves is a portion of the original wave. In a second step, the two waves 11, 12 propagate through media m1, m2 to generate waves 108, 110 having different phase retardation.

Young's experiment is another example of interference by wave front division. In Young's experiment, there is a monochromatic point source, and two spaced apart pinholes. The two pinholes split the incoming wave by wavefront division. The two light waves from the pinholes are coherent. Interference occurs between the two coherent light waves and produces interference fringes. The interference fringes vary according to the position of the observation plane. Because the interference pro perty depends on the spatial location of the two pinholes, the embodiment of Young's experiment cannot produce a singular interference pattern, and thus its applications are limited.

An amplitude division type of interferometer functions by splitting a light wave into two waves, delaying the split waves and then recombining the split waves into one wave. The Michelson, and Mach-Zehnder, type interferometers are representative of conventional interference devices that process light waves by amplitude division, (see FIGS. 1B-1C). As shown, the Michelson, and Mach-Zehnder type of interferometers need to use a beam-splitter, a fused-fiber coupler, or a Y branch, to split a wave. While splitting a wave using such components may facilitate light path management, this type of management results in bulky structures and causes stability problems in free space conditions, or causes coupling problems in integrated conditions.

Another well-known type of interferometer that functions by amplitude division is a Fabry-Perot interferometer. The Fabry-Perot interferometer primarily consists of two parallel reflectors. The Fabry-Perot interferometer is also called a Fabry-Perot etalon, or simply an etalon, when the distance between the two reflectors is fixed, or can be tuned. The etalons spectrum can be configured to contain a train of peaks that fall into wavelength grids such as the International Telecommunications Union (ITU) grids. An ITU grid etalon is widely used as a wavelength locker in light sources of an optical network. One of the properties of the etalon spectrum is its finesse. When finesse is much greater than 1, it can be described by the relationship:

Finesse=FSR/FWHM,

where FSR is the free spectral range (distance between two adjacent peaks), and FWHM is spectral width at half its maximum value. Finesse is limited by reflectivity of the reflectors and loss factors of the Fabry-Perot cavity. Thus, as the FSR increases, the FWHM also usually increases. However, in many applications, a large finesse, or reduced FWHM with similar or increased FSR is needed. For example, when an etalon is used in single mode lasing cavity, the etalon needs to have a large FSR. A large FSR ensures only a peak in spectrum occurring within the working range for a single mode output. A narrow bandwidth, or FWHM of etalon spectrum, is also needed, either for single mode selection, or for narrow line width output. Thus a device having a larger finesse is needed.

The etalon effect is sometimes unwanted (e.g., parasitic etalon effect in optical components). There is a parasitic etalon effect that occurs when there are two or more parallel or quasi-parallel surfaces, which are perpendicular, or quasi-perpendicular to the direction of wave propagations. A parasitic etalon effect deforms the spectrum shape, introduces noise, and, in some cases, interferes with the light source by feedback of parasitic etalon signals. Therefore, a need exists for controlling the parasitic etalon effect.

It is known that when two coherent waves of same wavelengths combine, interference occurs, and it is also known that the phase difference determines whether two waves are constructively interfered, or destructively interfered. Accordingly, if the two processed waves have a light path difference ΔL, their phase difference Δθ is a function of both the light path difference ΔL and the wavelength λ and is determined by the expression, Δθ=2πΔL/λ. Assuming the two waves have the same intensity I₀, the total intensity I is then given by one of the following two interference equations:

I=4I₀ cos²(Δθ/2) (1)

or

I=4I₀ cos²(πΔL/λ). (2)

(Ref: Hecht, Eugene, Optics, Chapter 9, page 336, (1987)). The total intensity I is a function of the phase difference Δθ. The phase difference Δθ is a function of both the light path difference ΔL and the wavelength λ. An interference spectrum is a plot of the intensity I versus wavelength λ at certain light path difference ΔL. Thus, to tune an interference spectrum, the phase difference must be tuned, or the light path difference must be varied.

In view of the foregoing problems in the field of interferometers, a need is seen to exists for a simple, compact interference device, for use in an optical interferometer, an inferometric modulator, an interferometric filter, and an inferometric laser.

A need is also seen to exist for an optical interferometer, an interferometric modulator, an interferometric filter, and an interferometric laser characterized by a having a simple, compact interference device in accordance with the present invention.

A need is further seen to exist for an optical device having a larger finesse than a conventional etalon.

### BRIEF SUMMARY OF THE INVENTION

An object of the present invention is to provide a simple and compact interference device that processes a wave by simultaneously performing wave front division and phase retardation, and for use in an optical interferometer, an interferometric modulator, an interferometric filter, or an interferometric laser, and method of fabricating the device. For an optical interferometer, a modulator, or a filter, the interference device is the main component along with possible collimating, focusing, and modulating or controlling sections. For an interferometric laser, the interference devices are employed to create interference in and/or out of a laser cavity. The interference device is independent of the laser power; and the wavelength is either fixed or tunable.

In its basic structure, the interference device of the present invention comprises at least two media through which a wave is split into at least two waves, and simultaneously, the phases of the at least two waves are retarded. The media are disposed in a manner such that at least one of the at least two waves propagates through one medium while the other wave(s) propagates through the other medium. After propagation through the at least two media, the wave comprises at least two wave portions, each portion having distinct phase retardation (i.e., phase differentiation). The optical structure of the present invention is distinguished from optical structure in the Rayleigh interferometer that first splits the wave into two waves, and then retards the phases of the two split waves. Thus, in accordance with the present invention, when the wave is focused (beam integration), interference occurs between the two waves. The interference spectrum is tuned by varying any combination of the medium characteristics (e.g., the index of refraction, the distance along which the wave travels in the medium, etc.).

The interference device may also comprise two reflectors for reflecting a wave. The reflectors are disposed in a manner such that each reflects a wave portion at a location distinct from the other reflector. After being reflected by these two reflectors, each of the reflected waves have a distinct phase retardation. Likewise, when the wave is focused, interference occurs between the two wave portions. An interference spectrum is tuned by moving one or both reflectors for creating a distinct phase difference.

The interference device may also comprise a slab disposed in a vacuum, a gaseous, a colloidal, or a liquid environment through which a wave portion may propagate. The slab can rotate about an axis disposed in a manner conducive to maintaining the propagation of the wave portion through the slab during slab rotation. After propagating through the slab, the wave comprises two wave portions, each portion having unique phase retardation. The phase difference of the two waves is determined by (1) the medium surrounding the slab, (2) the travel-distance that the wave portion travels through the slab, and (3) the refractive index of the slab. The travel-distance through the slab is a function of the slab thickness and of the angle between the length of the slab and a vector representing the direction of the wave propagation. When the wave is focused, interference occurs between the two wave portions. The interference spectrum is then tuned by rotating the slab about the axis.

The interference device may further comprise a guided wave in which two wave portions separately propagate through two distinct phase retardation regions having two distinct indices of refraction, thereby resulting in distinct phase retardation. These two wave portions are still guided. After each of the two wave portions exits from its respective phase retardation region, it comprises a phase difference. When the wave is either focused or launched in a waveguide, interference occurs. The interference spectrum is tuned by varying the index of refraction in the phase retardation regions.

The interference device of the present invention may still further comprise two etalons through which at least two light waves propagate separately. After passing through the two etalons, the two waves have different etalon interference spectra. The two etalon spectra have two sets of FWHM and FSR. The etalon with the longer cavity length has smaller FSR and FWHM than the etalon with the shorter cavity length. The two waves also have phase differences due to the etalon cavity. Interference between the two waves is two-wave interference. The resulting interference spectrum has a train of peaks with uneven amplitude. In a laser cavity, wavelength at the tallest peak has more chance to laser. Thus, an increased effective FSR with similar FWHM, or a reduced FWHM with similar effective FSR are achieved in the laser cavity.

The interference device of the present invention may still further comprise two etalons through which at least two light waves propagate separately for controlling the parasitic etalon effect. A second parasitic etalon is created from the existing parasitic etalon. By controlling interference between the two parasitic etalon spectra, unwanted spectrum ripples are reduced or converted to merit.

### BRIEF DESCRIPTION OF THE DRAWINGS

For a better understanding of the present invention, reference is made to the below-referenced accompanying drawings.

FIG. 1A is an optical diagram of a Rayleigh interferometer, as an example of an instrument, using wavefront division, in accordance with the related art.

FIG. 1B illustrates an optical diagram of a Michelson interferometer, as an example of an instrument, using amplitude division, in accordance with the related art.

FIG. 1C illustrates an optical diagram of a Mach-Zehnder interferometer, as an example of an instrument, using amplitude division, in accordance with the related art.

FIG. 2A illustrates an optical diagram of a first embodiment of an interference device, wherein a wave is processed through two media, in accordance with the present invention.

FIG. 2B illustrates an example of a two-wave interference pattern versus a ten-wave interference pattern.

FIG. 3A illustrates an optical diagram of a second embodiment of an interference device, wherein a wave is processed using two reflectors, in accordance with the present invention.

FIG. 3B illustrates an optical diagram of an alternate second embodiment of the interference device shown in FIG. 3A, in accordance with the present invention.

FIG. 4A illustrates an optical diagram of a third embodiment of an interference device, wherein a wave is processed using two tilting reflectors, in accordance with the present invention.

FIG. 4B illustrates an optical diagram showing the direction and angle of the two waves generated by the two tilting reflectors illustrated in FIG. 4A, in accordance with the present invention.

FIG. 5A illustrates an optical diagram of a fourth embodiment of an interference device, wherein one portion of a wave propagates through a slab while the other wave portion propagates external to the slab, effecting a distinct phase retardation, in accordance with the present invention.

FIG. 5B illustrates an optical diagram of an alternative fourth embodiment of an interference device, wherein one portion of a wave propagates through an angled slab while the other wave portion propagates external to the angled slab, effecting a distinct phase retardation, in accordance with the present invention.

FIG. 6A illustrates an optical diagram of a fifth embodiment of an interference device, wherein two guided waves are generated by two different wave guide regions, in accordance with the present invention.

FIG. 6B illustrates a perspective view of the fifth embodiment comprising two different regions in an optical fiber, in accordance with the present invention.

FIG. 7A illustrates an optical diagram of a sixth embodiment of an interference device, wherein two waves propagate through two etalons, in accordance with the present invention.

FIG. 7B illustrates an optical diagram of an alternative embodiment of the sixth embodiment shown in FIG. 7A, in accordance with the present invention.

FIG. 7C illustrates an optical diagram of the alternative sixth embodiment shown in FIG. 7C illustrating a parasitic etalon effect, in accordance with the present invention.

FIG. 7D illustrates an example of an interferometric modulator in accordance with the present invention.

FIG. 7E illustrates a graph showing a plurality of cavity modes and a spectrum of an introduced wave having a narrow bandwidth where a cavity mode coincides within the spectrum, in accordance with the present invention.

FIG. 8 illustrates an optical diagram of a single-mode semiconductor laser, in accordance with the present invention.

FIG. 9 is an optical diagram of a gain chip and a half wave generator formed for use in an interferometric laser, in accordance with the present invention.

FIG. 10 illustrates an alternative embodiment of the structure illustrated in FIG. 8, illustrating a high reflectivity reflector, a half-wave generator, a collimating lens, a gain chip with AR coating and a coupling lens, in accordance with the present invention.

FIG. 11 illustrates another alternative embodiment of the structure illustrated in FIG. 8, wherein a medium is added to the lasing cavity, in accordance with the present invention.

FIG. 12 illustrates an interferometric tunable laser which utilizes an interference device illustrated in FIG. 3A, in accordance with the present invention.

FIG. 13 illustrates an alternative embodiment of the interferometric tunable laser illustrated in FIG. 12, in accordance with the present invention.

FIG. 14 illustrates an alternative embodiment of the interferometric tunable laser illustrated in FIG. 12 with a tunable cavity, in accordance with the present invention.

FIG. 15 illustrates a single-mode laser structures utilizing curved reflectors and media with curved surfaces, in accordance with the present invention.

FIG. 16 illustrates a vertical cavity surface emitting laser with light wave interference in accordance with the present invention.

FIG. 17 illustrates an alternative embodiment of the structure illustrated in FIG. 8 with another half wave generator added, in accordance with the present invention.

FIG. 18 illustrates an alternative embodiment of the structure illustrated in FIG. 12 with a half wave generating function added, in accordance with the present invention.

Reference numerals refer to the same or equivalent parts of the present invention throughout the several figures of the drawings.

### DETAILED DESCRIPTION OF THE INVENTION

The present invention teaches an interference device for transforming a wave into two waves for use in an optical interferometer, an interferometric modulator, an interferometric filter, and an interferometric laser. A method of fabricating the device is also taught. The device of the present invention generally comprises at least two media through which a light wave simultaneously travels. The media are arranged in an optical structure such that the light wave is divided by wave front division into light wave portions that propagate in their respective media's light path and experience distinct phase retardation. The wave portions are then interfered by an interference means, such as a focusing.

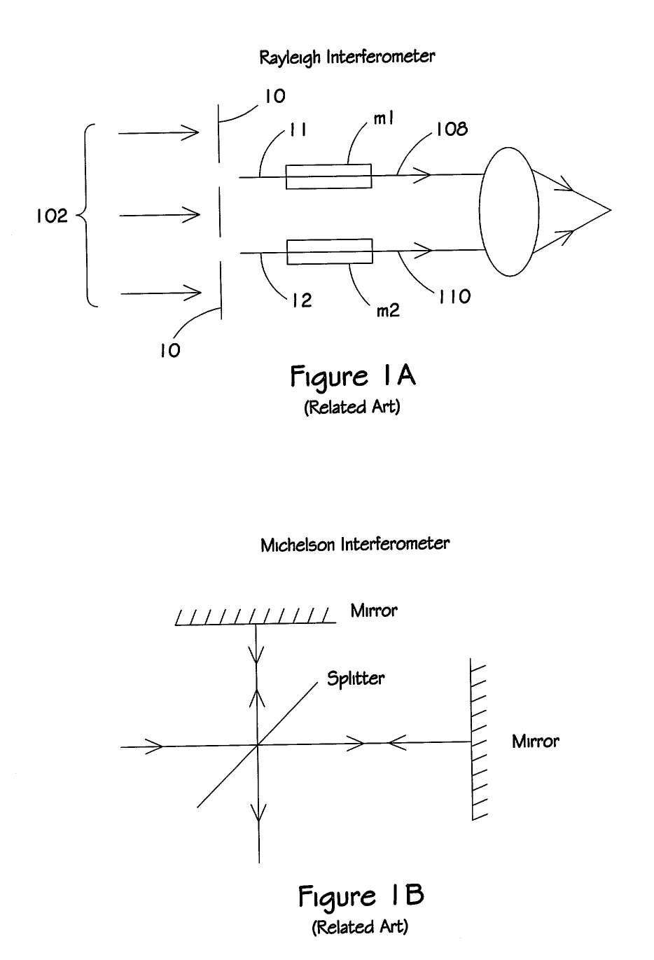

FIG. 1A illustrates an optical diagram of a Rayleigh interferometer, as an example of an interference instrument that performs wavefront division, in accordance with the related art. A light beam 102 is shown being transformed into two beams 11, 12 by two slits 10. Total power suffers loss due to the slits. The slits 10 that divide the wavefront do not facilitate phase retardation and requires placement of media m1, m2 for phase retardation to generate phase retarded beams 108, 110.

FIG. 1B is an optical diagram of a Michelson interferometer, as an example of an interference instrument that performs amplitude division, using physical beam separation, in accordance with the related art. A light beam is shown being split by a beam-splitter into two beams respectively incident upon two mirrors and being subsequently reflected back through the beam splitter. This is called interference by division of amplitude.

FIG. 1C is an optical diagram of a Mach-Zehnder interferometer, as an example of an interference instrument that performs amplitude division, in accordance with the related art. A light beam is shown being split into two beams by a first beam-splitter, the two beams simultaneously being reflected respectively by two mirrors, and the beams being subsequently combined by a second beam-splitter.

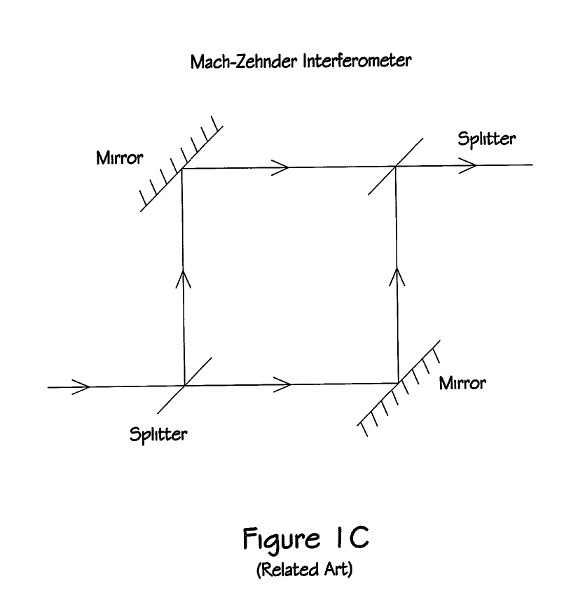

FIG. 2A illustrates, in an optical diagram, a first embodiment of an interference device in accordance with the present invention, wherein at least two light wave portions separately propagate through a respective media. A Gaussian beam 102 represents the input wave. The two media are a first medium 104 and second medium 106. The first medium 104 and the second medium 106 have refractive indices, n₁ and n₂, respectively. Travel-distances of the beam 102 through the first medium 104 and the second medium 106 are d₁ and d₂, respectively. The two media 104, 106 are disposed in a manner conducive to allowing a first beam 110, representing a first portion of total beam power, to propagate through the first medium 104, and a second beam 108 to propagate through the second medium 106. A lens 112, may be disposed aft of the media, for focusing the first beam 108 and the second beam 110 to effect interference. An interference spectrum is determined by the respective and distinct phase retardations of the first beam 108 and the second beam 110. The first beam 108 and the second beam 110 have phase difference expressed by

[n₁d₁−n₂d₂−nₑ(d₁−d₂)]2π/λ.

A peak wavelength λ of the interference spectrum is determined by interference equation:

n₁d₁−n₂d₂−nₑ(d₁−d₂)=mλ,

where nₑ is the refractive index of the ambience, n₁ and n₂ can be the same or different, and d₁ and d₂ can be the same or different. By changing any variable or any combination of the variables n₁, n₂, nₑ, d₁, d₂, the phase difference between the first beam 108 and the second beam 110 changes, thereby tuning the interference spectrum. For example, where temperature variation changes the refractive index, and if the medium is an electro-optical material, an applied electrical field determines the refractive index; and if the medium is a semiconductor, an injected current changes its refractive index. Therefore, the interference spectrum can be thermally or electrically tuned using either an electro-optical medium or a semiconductor medium.

If the refractive index is variable, the tuning range of the interference spectrum depends on the media configuration, as shown FIG. 2. For example, assuming the refractive index is variable, as in FIG. 2, a change in the peak wavelength is derived from the interference equation as

Δn₁d₁−Δn₂d₂=mλ,

where m remains a constant. If only n₁ is variable, tuning of the peak wavelength is proportional to Δn₁·d₁. Thus, d₁ functions as a magnification factor for a change in peak wavelength. If both refractive indices n₁ and n₂ are variable, but varying in opposite directions, then d₁ and d₂ collectively serve as a magnification factor.

Furthermore, the embodiment is not limited to the configuration shown in FIG. 2A. The present device may also comprise an arrangement of different media which creates at least two wave portions with a phase difference. For example, medium 104, 106 can be a combination of different media, or part of medium 104, 106 can be a piece of the same medium.

Furthermore, this embodiment is not limited to creating a phase difference between wave portions. While an interference between two half waves is a two-wave interference, an alternative first embodiment exists wherein the wave is transformed into 2N waves where N is an integer. The phase difference between two successive waves is Δθ. Assume the 2N waves have the same intensity I₀, multi-wave interference between the 2N waves has intensity described by:

I=I₀{sin²(2NΔθ/2)}/{sin²(Δθ/2)}.

FIG. 2B shows an example of two-wave interference versus 10 wave interference. Multi-wave interference has a narrower spectral bandwidth than that of two-wave interference. The larger the number of waves in interference, the narrower the bandwidth. If multi-waves have same phase difference but unequal intensity, the interference still makes spectral bandwidth narrower compared to two-wave interference.

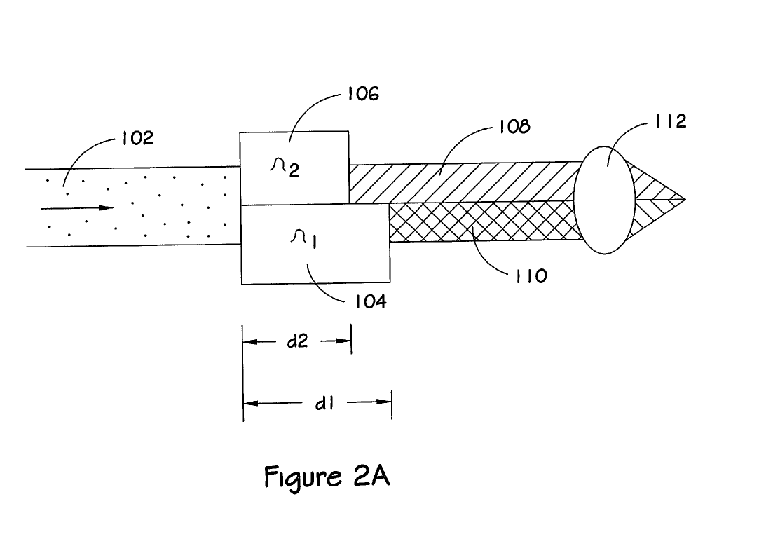

FIG. 3A illustrates, in an optical diagram, a second embodiment of an interference device, wherein two waves are generated by two reflectors, in accordance with the present invention. A collimating lens 116 converts a wave 118 into a Gaussian beam 102 Two reflectors 120, 122 are flat and disposed in parallel to each other. The beam 102 is perpendicularly disposed to reflector 120, 122. Each of the two reflectors 120, 122 reflects beam 102.

FIG. 3B illustrates, in an optical diagram, a second embodiment of an interference device, wherein two waves are being reflected by the two reflectors, in accordance with the present invention. The reflector 120 and the reflector 122 are disposed in different locations to create distinct phase retardation for each reflected wave. Interference occurs between first wave 108 and second wave 110 by focusing the waves using the lens 116. Assuming that the reflector 120 and the reflector 122 are separated by distance d, a peak wavelength λ of the interference spectrum is determined by the relationship:

2nₑd=mλ,

where nₑ is ambient index of refraction and m is an integer. The interference spectrum is tuned by changing the distance d between the two reflectors and/or the refractive index of ambiance nₑ.

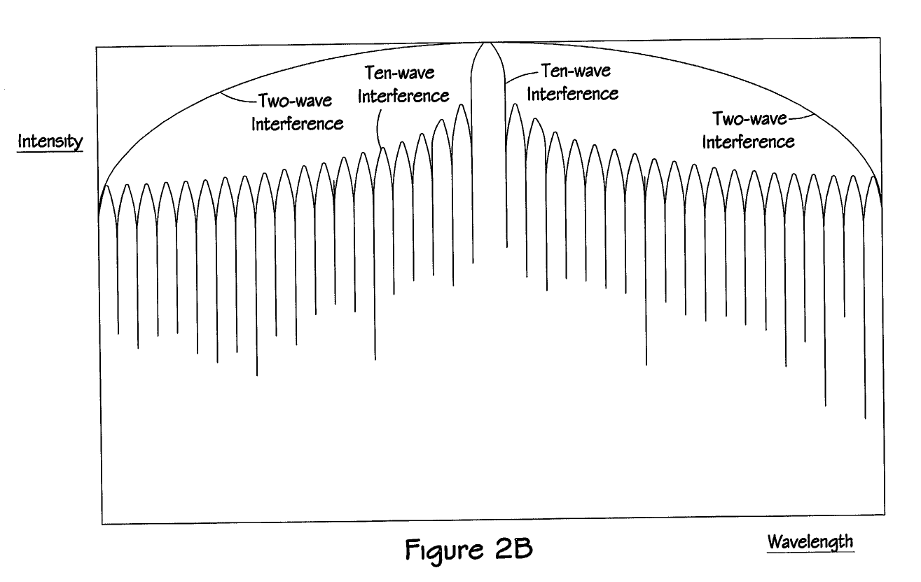

FIG. 4A illustrates, in an optical diagram, a third embodiment of an interference device, wherein a Gaussian beam 102, is being reflected by two reflectors 124, 126 to generate two waves 128, 130, in accordance with the present invention. A Gaussian beam 102 is reflected by two reflectors 124, 126. The two reflectors 124, 126 are flat and disposed in parallel to each other. The beam 102 is not perpendicularly disposed in relation to the reflectors 124, 126. A reflected first beam 128 and a reflected second beam 130 are separated. The separation x of the first beam 128 from the second beam 130 depends on (1) a tilting angle (β formed between the beam 102 and the two reflectors 124, 126 and (2) a distance d defined between the reflector 124 and the reflector 126. Separation x of the first beam 128 and the second beam 130 is determined by the expression 2d sin φ. Thus, decreasing either d or φ results in a smaller separation x.

FIG. 4B illustrates, in an optical diagram, the third embodiment FIG. 4A, showing the direction and angle of the two waves 128, 130 as they are being generated by the two tilting reflectors 128, 130, in accordance with the present invention. The two reflectors 124, 126 effect different phase retardation for each of the two beams 128, 130, which is expressed as (2nₑd cos φ)_/λ, where nₑ is the ambient refractive index (m is an integer). When the first beam 128 and the second beam 130 are focused, interference occurs. A peak wavelength λ of the interference spectrum depends on the relation: 2nₑd cos φ=mλ

where m is an interger.

The interference spectrum is tuned by changing any or any combination of the angle φ, the distance d, and the ambient refractive index nₑ.

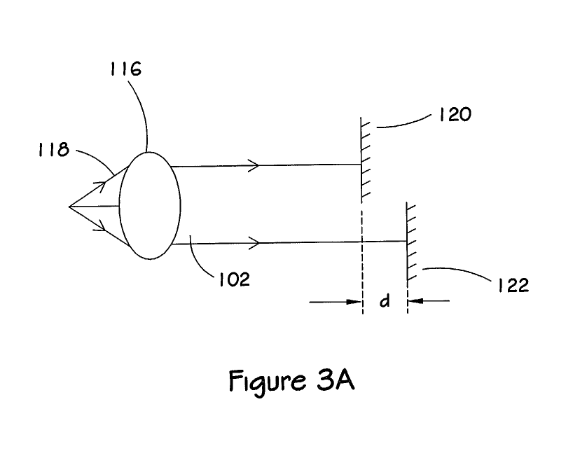

FIG. 5A illustrates, in an optical diagram, a fourth embodiment of an interference device, wherein a wave portion propagates through a slab while the remaining wave portion propagates through the medium, effecting a distinct phase retardation, in accordance with the present invention. A slab 132 is perpendicularly disposed in relation to a direction of the wave propagation; and a Gaussian beam 102 represents a wave while nₑ is the ambient refractive index. The slab 132 is disposed in a manner such that the first wave portion 102 propagates through the slab 132. After passing through the slab 132, the beam 102 comprises two light beam portions, a first light beam portion 108 and a second light beam portion 110. The slab 132 is flat for the Gaussian beam 102 and may comprise an anti-reflection coating disposed on both an incident facade and an outgoing surface. The light beam portions 108, 110 have phase difference given by the expression:

(n−nₑ)d/λ,

where n is the slab refractive index, nₑ is ambient refractive index, and d is the slab thickness. When the two light beam portions 108, 110 are focused, interference occurs. A peak wavelength λ of interference spectrum is determined by the equation:

(n−nₑ)d=mλ,

where m is an integer.

FIG. 5B illustrates, in an optical diagram, an alternative fourth embodiment of an interference device, wherein one of light beam portions propagates through an angled slab while the remaining light beam portion propagates through the medium, effecting a distinct phase retardation, in accordance with the present invention. When the slab 132 is perpendicularly disposed in relation to the beam 102, both a beam incidence angle and a refraction angle are zero degree. However, if the slab 132 is tilted by an angle α, the incidence angle is also α, and refraction angle becomes β. The incidence angle α and the refraction angle β are both related by Snell's law of refraction:

nₑ sin α=n sin β.

The distance d traveled by the beam 102 is then given by

d/cos β.

The phase difference between the first light beam portion 108 and the light beam portion 110 is changed to

(n−nₑ)·d/(λ cos β_)

The peak wavelength λ of interference spectrum now depends on

(n−nₑ)·d/cos β_{—}=mλ.

Therefore, the interference spectrum can be tuned by rotating the slab 132 about axis A-A shown n FIG. 5A. A rotational axis of the slab 132 is disposed in a manner facilitating portion of the beam 102 being propagated through the slab 132 during rotation. A method of achieving this goal is to have a rotational axis perpendicularly disposed in relation to the beam 102.

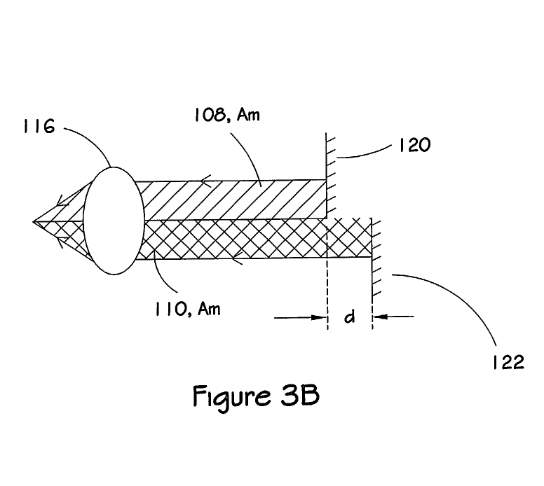

FIG. 6A illustrates, in an optical diagram, a fifth embodiment of an interference device, wherein two guided wave portions pass through two different regions of a differentiating waveguide, in accordance with the present invention. A wave 144 propagates in an entry waveguide 134. A first region 136 and a second region 138, each region having a distinct refractive index, are located within the waveguide 134. When the wave 144 enters regions 136, 138, it remains guided. However, one portion of the wave experiences one refractive index, and the other portion of the wave experiences different refractive index. After the wave 144 exits the differentiating waveguide, the wave 144 enters another waveguide 140, an exit waveguide, wherein the wave 144 comprises two wave portions, each having a different phase retardation. Assuming n₁₃₆ and n₁₃₈ are the respective effective indices of refraction in regions 136, 138. A phase retardation between the two wave portions in the exit waveguide 140 is given by

(n₁₃₆−n₁₃₈)d=mλ,

where d is the travel distance in regions 136, 138. Interference occurs between the two wave portions in waveguide 140. The peak wavelength X of the interference spectrum is determined by

(n₁₃₆−n₁₃₈)d=mλ,

where m is integer.

FIG. 6B illustrates, in a perspective view, the fifth embodiment of an interference device comprising two different regions, in accordance with the present invention. An optical fiber 148 comprises two fiber regions, wherein a first fiber region 150 has one refractive index while the other fiber region 152 has different index of refraction. A difference in refractive index is unnecessary in areas away from the core of fiber, since a wave propagates mainly within a core region. After the wave passes through the fiber regions 150, 152, it re-enters the fiber 148 with two wave portions having different phase retardation. Single mode interference occurs if the fiber 148 is single mode. If fiber 148 is multi-mode, interference occurs within different modes. Fiber regions 150, 152 can be in any form which creates two wave portions having different phase retardations. The interference spectrum can be tuned by changing indices n₁₃₆ or n₁₃₈ thermally, or electrically, for example, by using either electro-optical materials or current-injection with semiconductor materials, the interference spectrum can also be tuned electrically.

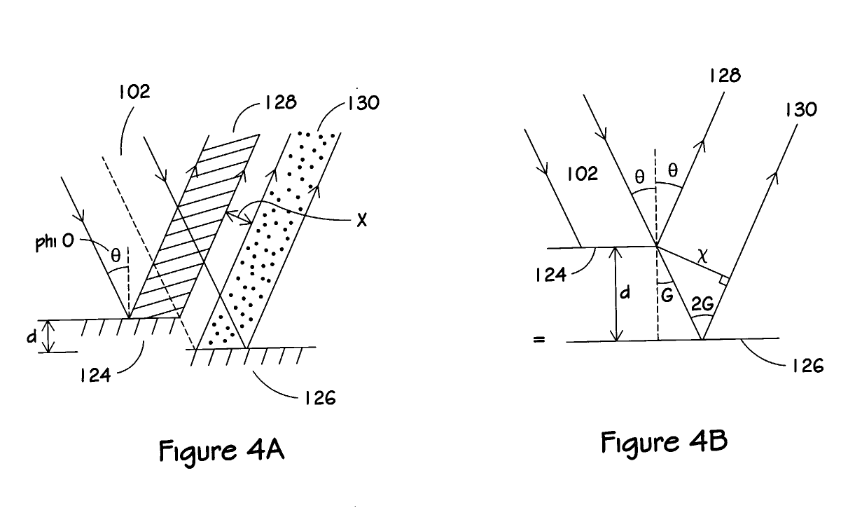

FIG. 7A illustrates, in an optical diagram, a sixth embodiment of an interference device, wherein two light wave portions propagate through two etalons, in accordance with the present invention. A Gaussian beam 102 passes through etalons 166, 168, which have a refractive index of the cavity n₁, n₂, and a cavity gap d₁, d₂ separately. The two etalons 166, 168 are placed such that light beam 102 propagates through the etalons 166, 168. Due to the etalon effect, the beams 108, 1110 have different spectra and phase retardation. Assuming normal incidence, etalon spectrum is described by an equation of transmitted intensity, namely:

I=T²I₀/{(1−R)²+4R sin²(2πnd/λ)},

where T is reflector transmittance, R is reflector reflectance, I₀ is incident intensity, n is refractive index of cavity, d is cavity length. The equation of transmitted amplitude is given by:

U=AT/{1−Re^{i4πnd/λ}},

where A is amplitude of incident wave. Thus, assuming d₁>d₂, the phase difference between the two waves is:

4π{(n₁d₁+ne(d₂−d₁)−n₂d₂)}/λ,

assuming nₑ is the refractive index of the ambience. When the two waves interfere with each other, the resulting amplitude is:

U=A₁T₁/{1−R₁e^{i4πn1d1/λ}}+A₂T₂/{1−R₂e^{i4πn2d2/λ}}.

The interference spectrum contains a train of peaks with peak amplitude dependent on properties of the two etalons. In resonant lasing cavity, the wavelength at the highest peak has more chance to lase. Thus, the effective FSR becomes the distance between the two peaks with maximum amplitude, which means the effective FSR is at least larger than that of the etalon with larger cavity length. The FWHM at the highest peak is also reduced when compared to that of the etalon with shorter cavity length. Therefore, in a laser cavity, there is achieved an increased effective FSR with similar FWHM, or a reduced FWHM with similar effective FSR. When the refractive index of etalon cavity is tunable, the resulting spectrum becomes tunable and has potential applications in tunable lasers. By example an etalon cavity may be fabricated from semiconductor materials which utilize current injection or temperature control to tune the refractive index of the cavity. Additionally, the characteristics of the etalon can be tuned by grinding and polishing.

FIG. 7B illustrates, in an optical diagram, an alternative sixth embodiment of an interference device, wherein two waves 108, 110 propagate through two etalons, in accordance with the present invention. The two etalons physically and integrally form one piece of material.

FIG. 7C depicts a parasitic etalon effect wherein optical component 165 comprises two parallel surfaces 161 and 163. Gaussian beam 102 is shown perpendicular to surfaces 161 and 163. Even with anti-reflection coatings, the two parallel surfaces 161 and 163 still functions as an etalon. The parasitic etalon transforms beam 102 into beam 103. Beam 103 carries parasitic etalon spectrum. By making a thickness difference, such as shown in FIG. 7B , an additional etalon is made. By introducing a second etalon and a beam portion interference of two etalon spectrum, the parasitic etalon effect can be modified by manipulating the interference. For example, peak at a certain wavelength can be enhanced by constructive interference; and unwanted parasitic interference peaks are treated with destructive interference. Therefore, the problems caused by a parasitic etalon can be either reduced or even converted to merit.

The foregoing embodiments of interference devices are conducive for use in an interferometer, an interferometric modulator, and an interferometric filter. An interferometer needs a light source, an interference device, and devices for verifying or measuring interference. Through analysis of interference, high precision measurement can be achieved. Due to the novel structure, fewer components are needed in contrast to conventional related art interferometers. The resulting interferometer comprising the instant device is compact and simple. When the interference spectrum is tuned, the spectral peak and valley positions move. Thus to modulate intensity of a wavelength is to tune interference spectrum. By the novel structure, fewer components are needed when comparing to conventional interferometric modulator. The resulting interferometric modulator is compact and simple.

FIG. 7D shows an example of an interferometric modulator. Fiber 172 and 174 are the input and the output. 160 and 163 are collimating lenses and half-wave generator 162 transforms one wave into two waves. Interference happens when the two wave portions are coupled into fiber 174 through collimating lens 163. After being coupled into fiber 174, the surviving transmitted waves have spectrum defined by said interference. Modulation is determined by the interference equation

I=4I₀ cos²(πΔL/λ),

where ΔL is light path difference of the two waves. The insertion loss is smaller by using collimating lens, when comparing with coupling loss between waveguide and fiber in waveguide intensity modulator.

As a peak of interference spectrum is used to transmit waves of certain wavelength while a valley is used to block waves of certain wavelength, an interferometric filter of fixed wavelengths results from an interference device of a fixed wavelength. Among interferometric filters of fixed wavelength, an interference device, comprising an optical fiber of the type shown in FIG. 6B, leads to a simple structure. This interference device can be used as an interferometric filter with fiber input and fiber output. An interferometric filter of tunable wavelength results from an interference device of tunable wavelength. All of the foregoing embodiments of the present device for tuning an interference spectrum can be utilized in an interferometric filter. The resulting interferometric filter is compact and simple.

In fiber optical communication, light source usually is single mode, i.e., both single longitudinal mode and single transverse mode. Single longitudinal mode means that there is only one spectral peak in working wavelength range. Single mode output requires selection of a single cavity mode, or a single cavity spectral peak. For that purpose, a wave with narrow bandwidth is introduced in lasing cavity. Narrow bandwidth of the introduced wave ensures that only one cavity mode coincides with it, as shown in the example in FIG. 7E, where 194 are cavity modes and 196 is spectrum of introduced wave. Introduced wave can also have multiple peaks as long as it results in single mode output. One method to introduce waves in a cavity involves creating light wave portions inside or outside of the lasing cavity. Each of the two light wave portions has a distinct phase difference. The single mode active region serves as a place where the light wave portions interfere. The interference spectrum becomes spectrum of the introduced wave. Due to coherent feature of laser beams, interference in lasing cavity is multi-wave interference. Assume lasing cavity causes light path difference Δ for a round trip, and the two-phase generator causes phase difference δ after a round trip. After two round trips, the wave becomes For different laps (round trips), phase difference becomes

1 lap: Δ±δ

2 laps: 2Δ±δ±δ

3 laps: 3Δ±δ±δ±δ

K laps: KΔ+Σ±δ.

Therefore the interference is multi-wave interference, which can be approximately constructed as interference between multiple etalon spectra whose phase difference between two successive waves is δ. Since multi-wave interference has narrower bandwidth than that of two-wave interference as shown in FIG. 2′, the interferometric method selects cavity mode efficiently. If the interference spectrum is fixed, it is a single-mode laser with fixed wavelength. If the interference spectrum is tunable, it is a tunable single-mode laser.

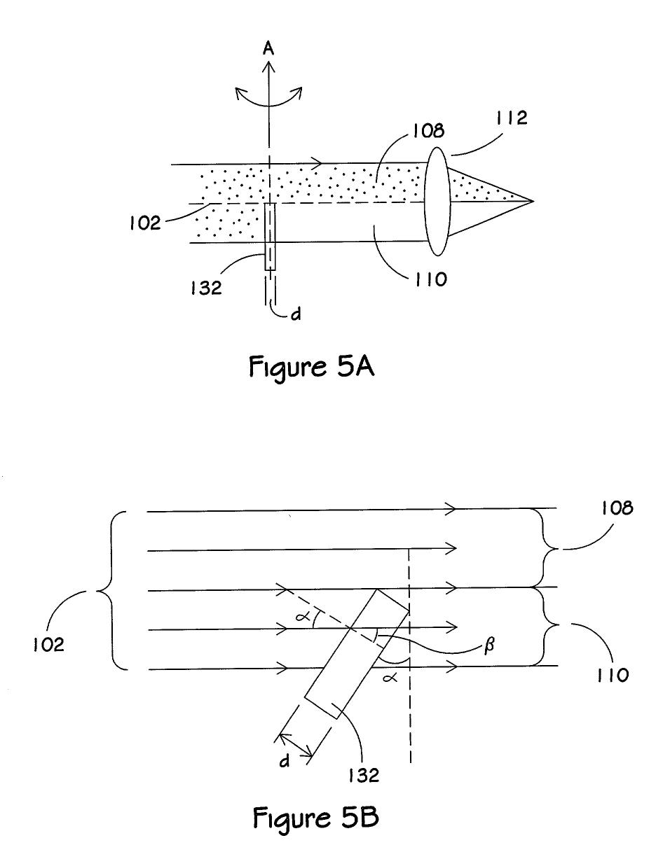

FIG. 8 illustrates, in an optical diagram, a single-mode semiconductor laser comprising: a semiconductor gain chip 154, the chip 154 comprising a gain medium with broad band output, and a half wave generator 162 as the device to control interference, in accordance with the present invention. A gain chip 154 comprises a rear high reflection (HR) coating 156 and front low antireflection (AR) coating 158. A lens 160 collimates light from the gain chip 154. A partial reflector 164 reflects a beam back to the gain chip 154. A lasing cavity is disposed between the HR coating surface 156 and a reflector 164. Disposed between the lens 160 and the reflector 164, is the half wave generator 162 which converts one beam into two beams, each having a different phase retardation. The half wave generator 162 is the core structure of the foregoing embodiments. The gain chip 154 is disposed forward of the half wave generator 162. Since a light beam portion propagates through the half wave generator 162 twice in one circulation, the phase difference between the light beam portions is twice that of a single pass case. For instance, a single mode tunable semiconductor laser may comprise the instant interference device. The resulting structure of the interferometric laser is likewise compact and simple.

Also referring to the device as shown in FIG. 8, an oscillating wave traveling inside of the gain chip is a guided wave. With regions of different refractive index, a first portion of the guided wave in the gain chip experiences one refractive index, while the second portion of the guided wave experiences a different refractive index. After propagating through the region, each of the wave portions has a different phase retardation. In the single mode laser, interference occurs after the wave portions exit the phase retardation region. In the multi-mode laser, interference occurs only partially. If the phase retardation region is fixed, the interferometric laser has a fixed wavelength output. If the phase retardation region is adjustable (e.g., tuned electrically through current injection), the interferometric laser is a tunable laser. The resulting interferometric laser of fixed wavelength will have similar characteristics to that of a distributed feedback (DFB) laser. However, the resulting interferometric laser of fixed wavelength also has a simpler structure than that of the DFB laser, since the DFB laser must form a grating structure. The resulting interferometric laser of tunable wavelength has simpler structure than that of the distributed Bragg reflector (DBR) laser, since the DBR laser has grating structures.

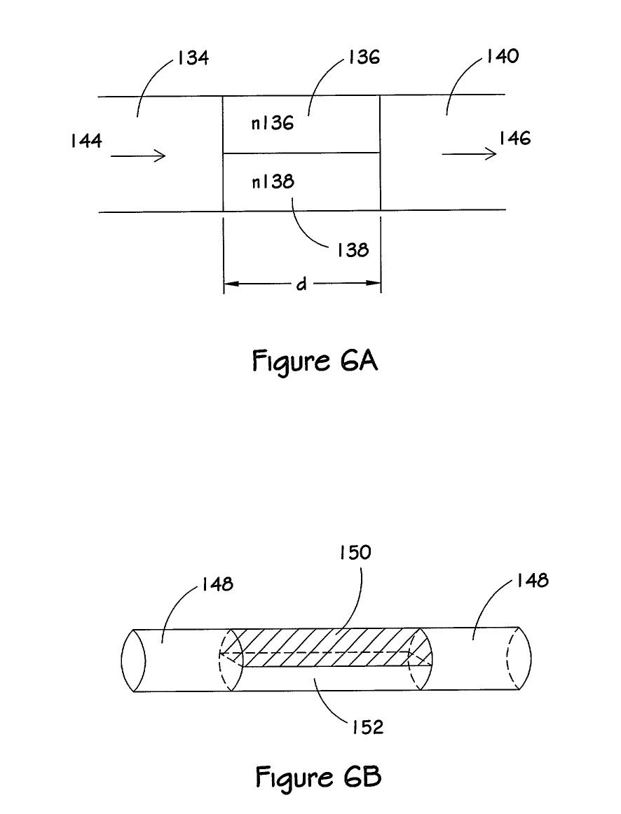

FIG. 9 illustrates, in an optical diagram, two interference devices comprising: a gain chip having a high-reflection (HR) coating disposed at one end and an antireflection (AR) coating disposed at the other end; and a half guided wave generator as the interference device also having a high-reflection (HR) coating disposed at one end and an antireflection (AR) coating disposed at the other end, as would be used in an interferometric laser, in accordance with the present invention. A gain chip 154 has HR coating 156 and AR coating 158. A half guided wave generator 170 has a structure similar to that shown in FIG. 6A and has HR coating 168 and AR coating 166. The gain chip 154 and the half guided wave generator 170 are coupled with minimum loss. The gain chip 154 mainly determines output power. The half guided wave generator 170 locks a desired wavelength through the interference device.

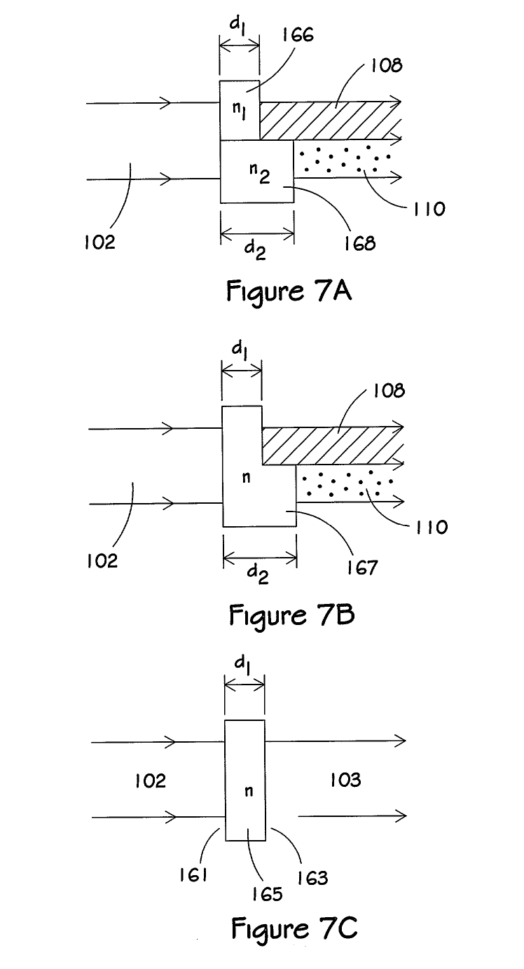

An alternative of the structure in FIG. 8 is shown in FIG. 10, where 176 is a high reflectivity reflector, 162 is half-wave generator, 160 is collimating lens, 154 is gain chip with AR coating 182 and 184, 178 is coupling lens to couple output into fiber 180. The lasing cavity is between reflector 176 and AR coating layer 184. Comparing the mode created between coatings 156 and 158 in FIG. 8, the mode created between 182 and 184 in FIG. 10 is weakened.

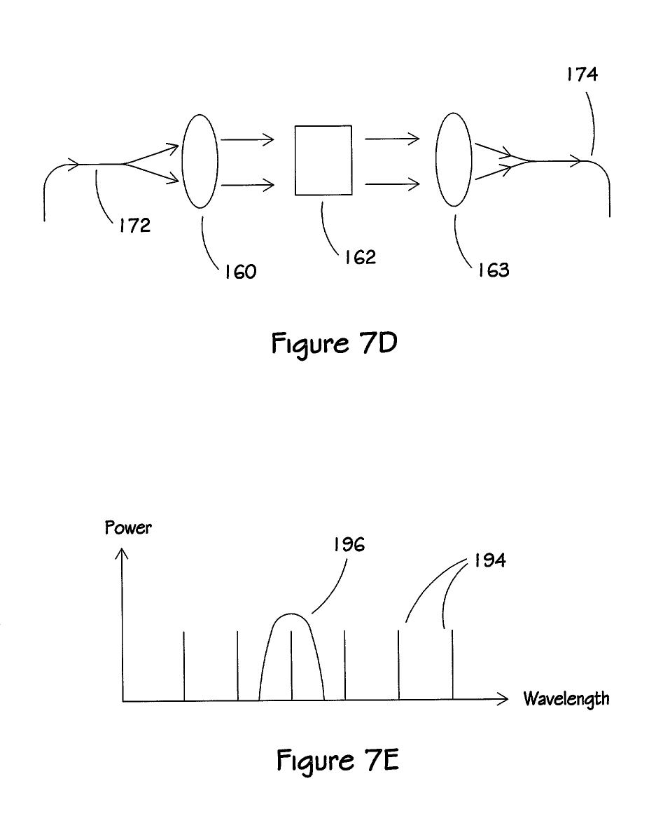

FIG. 11 is another alternative of the structure in FIG. 8. A medium 300 is added to the lasing cavity between reflectors 176 and 164. Medium 300 has tunable light path and AR coating on both ends. Reflector 176 has high reflectivity. Reflector 164 is a partial reflector. In the cavity, 160 and 161 are is collimating lenses, gain chip 154 has coatings AR coating 182 and 184. Total cavity length is Σnᵢdᵢ, where nᵢ and dᵢ are refractive index and length wave travels in each section. As we know from previous discussion, there is

2Σnᵢdᵢ=mλ.

The above equation determines the position of peaks of cavity resonant spectrum, or cavity modes. Tunable light path of medium 300 results from either tunable refractive index, or tunable path along which wave travels. Due to medium 300, cavity mode is tunable. With a tunable cavity mode, more accurate wavelength is achieved. Tunable mode also enables continuous tuning. If medium 300 is inserted in lasing cavity in FIG. 10, similar results are achieved in terms of wavelength accuracy and continuous tuning.

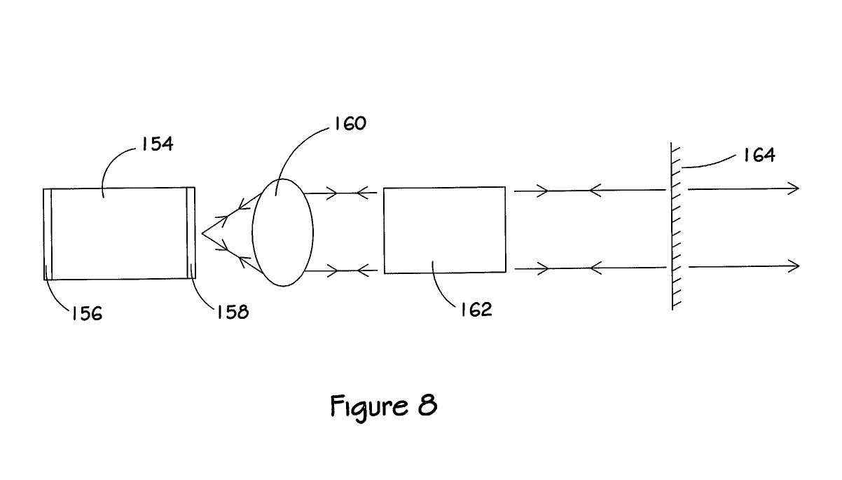

FIG. 12 depicts another embodiment of interferometric tunable laser, comprising gain chip 154 having HR coating 156, AR coating 158, collimating lens 160 and two partial reflectors 186, 188. The tunable laser makes use of the structure in FIG. 3A. Reflector 186 and 188 are parallel and the distance d between them determines interference spectrum. A lasing cavity is between HR coating 156 and partial reflectors 186 and 188. By changing the distance d, interference spectrum is tuned, which in turn tunes the wavelength of output. Methods of tuning distance d include micro-electromechanical systems (MEMS), piezoelectric actuators, and other electromechanical means.

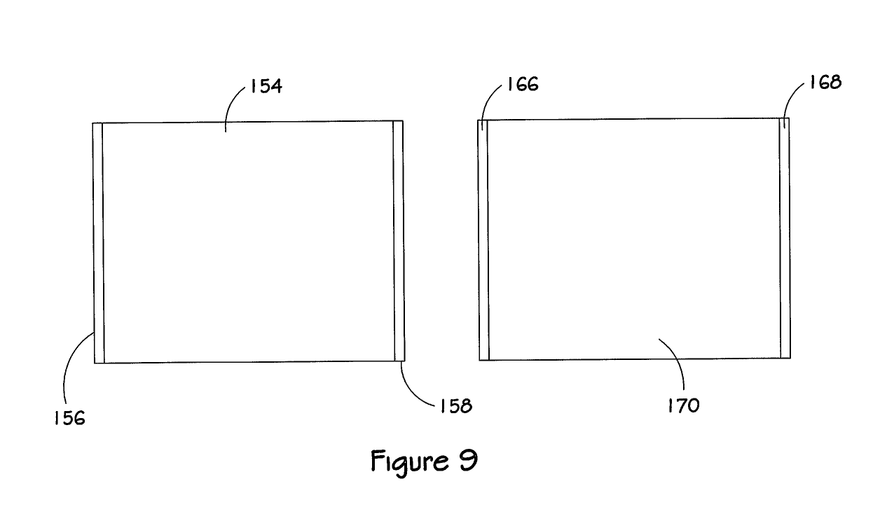

An alternative of the structure in FIG. 12 is shown in FIG. 13. Gain chip 154 has low AR coating 182 and AR coating 184. 160 and 178 are collimating and coupling lens separately. Output is coupled into fiber 180. Elements 190 and 192 are two reflectors with high reflectivity, and are parallel. A lasing cavity is between AR coating 184 and the two reflectors 190 and 192. Like in FIG. 12, tuning is achieved by changing the distance between 190 and 192. Alternative of the structures in FIGS. 12 and 13 have tunable cavity length, thus tunable cavity modes. Tunability of cavity length is achieved by moving the two parallel reflectors together without changing the distance between them.

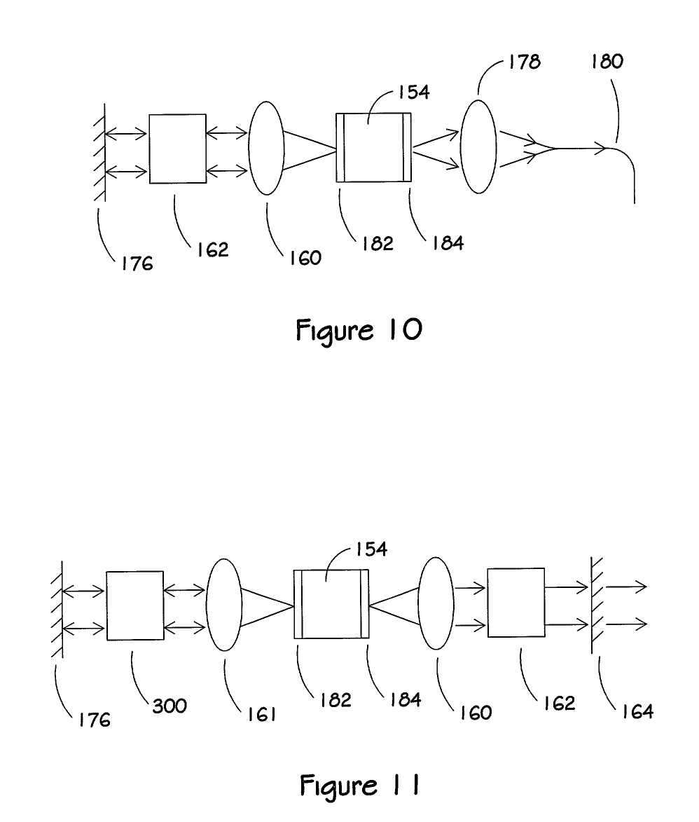

Another alternative of FIG. 12 with tunable cavity length is shown in FIG. 14. Like the structure in FIG. 11, tunable cavity length is created by tunable medium 300, which has AR coatings on both ends, 176 is a HR reflector, 161 and 160 are collimating lenses. Gain chip 154 has AR coating 182, 184 on both facets. Changing reflectivity of reflectors 176, 186, 188 leads to an alternative of FIG. 14. Output wave comes out of reflector 176 instead of the two reflectors 186 and 188.

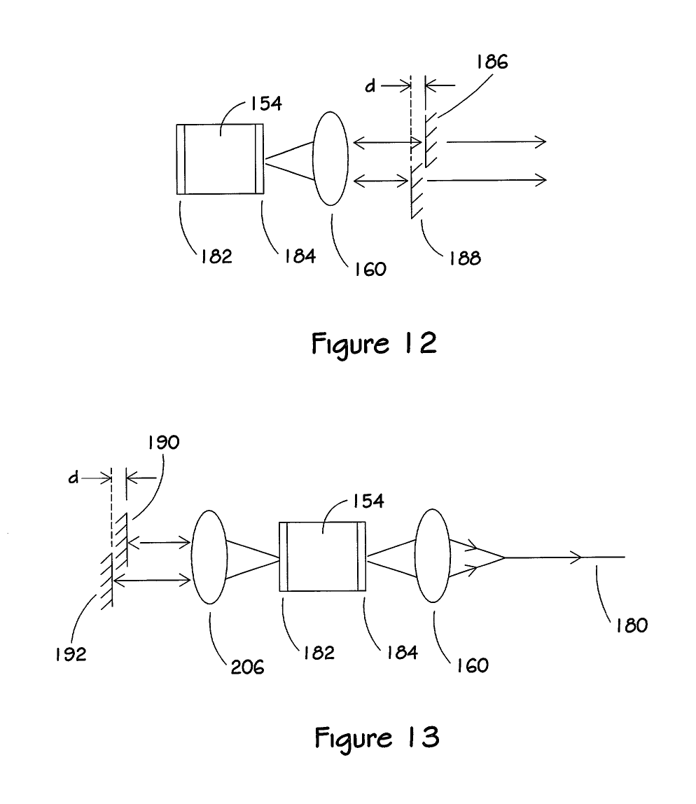

Yet other alternatives of the above single-mode laser structures involve curved reflectors and media with curved surfaces so that collimating lens is taken away. An example is given in FIG. 15 as an alternative of the structure shown in FIG. 13. Comparing FIG. 15 with FIG. 13, two, curved HR reflector 194, 196 replace reflector 190 and 192, and collimating lens 160.

Yet other alternatives of above single-mode laser structures involve two half wave generators in lasing cavity and a gain chip with both facets AR coated. The two half wave generators are at two sides of the gain chip. The new configuration doubles process of interference among wave portions. If the two half wave generators are identical, multi-wave interference is enhanced by the number of interference. It results in even narrower spectral bandwidth. If the two half wave generators are different, interaction between two multi-wave interference can also lead to narrower spectral bandwidth.

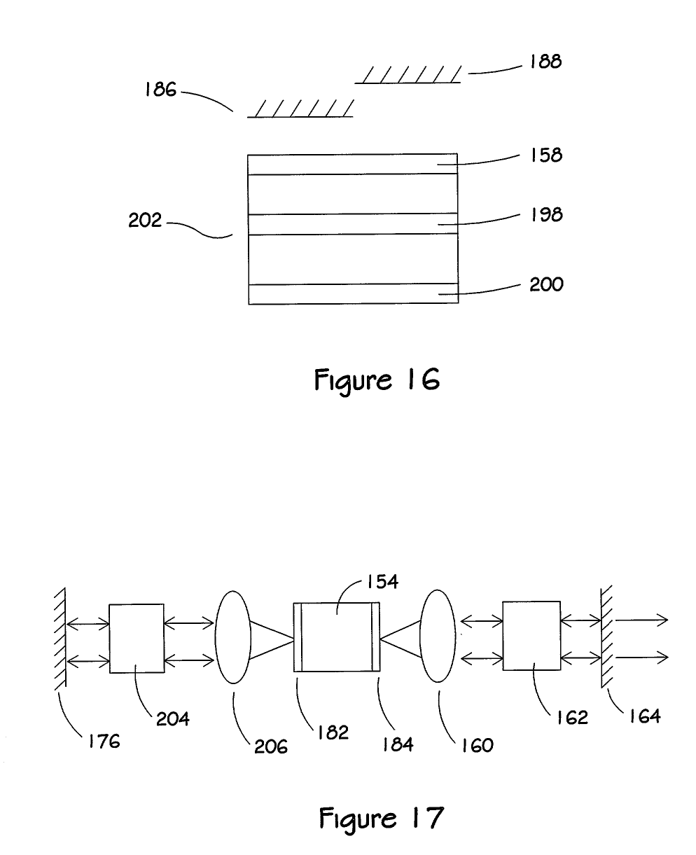

An alternative of structure in FIG. 8 is shown in FIG. 17. In FIG. 17 another half wave generator 204 is added, along with HR reflector 176, collimating lens 204. Gain chip 154 has two AR coating 182 and 184. Alternatives of structures in FIGS. 10 and 11 can be achieved with similar addition of half wave generator.

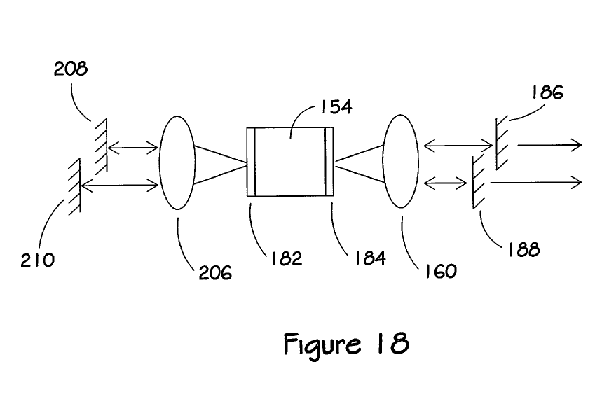

An alternative of structure in FIG. 12 is to add another half wave generating function as in FIG. 18. As shown, part of the structure of FIG. 12 remains the same, e.g., partial reflector 186, 188, and collimating lens 160. Gain chip 154 has both facets with AR coating 182 and 184. Element numeral 206 is another collimating lens. HR reflector 206 and 208 are parallel and each reflects half-waves like reflectors 186 and 188. Alternative of the structures in FIGS. 13, 14, 15 can be achieved with similar considerations.

If more-than-two wave generator is used to replace two-wave generator in lasing cavity, narrower spectral bandwidth can be achieved due to enhanced multi-wave interference, with principles similar to having two two-wave generators in the cavity.

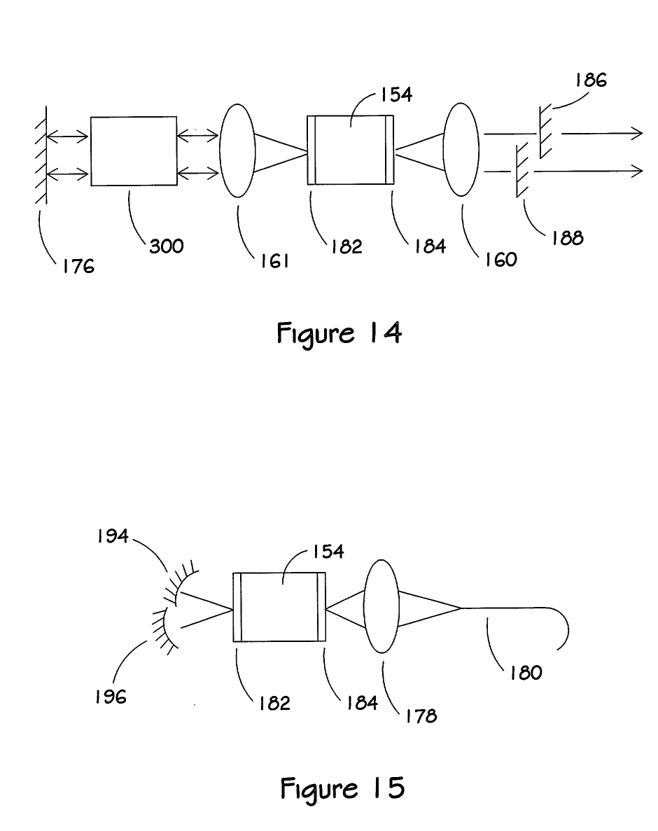

The half-wave interferometric schemes can also be applied to vertical cavity surface emitting laser (VCSEL). For single longitudinal mode, VCSEL demands either a very short cavity length. Short cavity length ensures that there is only peak within working wavelength range. The peak position determines output wavelength. Half-wave interference enables much longer cavity length in single longitudinal mode operation, whose principles are discussed in above paragraphs. VCSEL with half-beam interference can have fixed or tunable wavelength. FIG. 16 gives an example of VCSEL with half-wave interference. The principle is similar to that in FIG. 12. Chip 202 comprises active layer 198, AR coating 158, HR reflector 186, 188, and 200. Reflector 186 and 188 are parallel and reflect half-waves separately. The HR reflectors are needed for getting enough power out of a thin active layer. The distance between reflector 186 and 188 determines resulting interference spectrum. The tuning process is same as that in FIG. 12. Light can emit from both directions.

Information as herein shown and described in detail is fully capable of attaining the foregoing object of the invention, the presently preferred embodiment of the invention, and is, thus, representative of the subject matter broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” Further, wherein reference is made to “two” elements, this is not intended to mean “two and only two” unless explicitly so stated, but rather “two or more.” All structural and functional equivalents to the elements of the foregoing preferred embodiment and additional embodiments, that are known to those of ordinary skill in the art are hereby expressly incorporated by reference, are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, various changes and modifications in form should be readily apparent to those skilled in the art, optical material, and fabrication material detail may be made without departing from the spirit and scope of the invention as set forth in the appended claims. No claim herein is to be construed under the provisions of 35 U.S.C. '112, sixth paragraph, unless the element is expressly recited using the phrase “means for”.

What is claimed:

1. An optical interference device for generating a single interference spectrum of a light wave, said interference device comprising:
a. means for simultaneously performing and producing different phase retardation on said light wave and generating at least two wave portions of said light wave; and
b. means for interfering said at least two wave portions and generating said single interference spectrum.

2. A device of claim 1, wherein said device comprises a tunable interference device, said device being tunable by modifying at least one parameter selected from a group of parameters associated with said means for performing wave front division and said means for interfering, said group of parameters consisting essentially of a refraction index, a distance traversed by each said at least two light wave portions, a location, an orientation, an environment, and a thickness.

3. A device of claim 1, wherein said device comprises a fixed wavelength type of interference device.

4. A device of claim 1, wherein said means for performing wave front division comprises at least two media, each medium of said at least two media having a distinct index of refraction through which said light wave propagates, said at least two media being disposed such that one of said at least two wave portions propagates through one medium, while another one of said at least two wave portions propagates through another medium of said at least two media.

5. A device of claim 1, wherein said means for interfering comprises at least one lens for focusing said at least two light wave portions.

6. A device of claim 1, wherein said at least two light wave portions propagate by a manner selected from a propagation group consisting essentially of simultaneous propagation and sequential propagation.

7. A device of claim 1, wherein said means for interfering is further disposed aft of said means for performing wave front division.

8. A device of claim 1, wherein said means for performing wave front division comprises at least two reflectors for generating said at least two light wave portions, and wherein each reflector, of said at least two reflectors, is disposed at a distinct location such that each said reflector reflects respective portions of said light wave.

9. A device of claim 1, wherein said means for performing wave front division comprises a slab, said slab being rotatable about an axis for facilitating tuning of said interference spectrum, said axis being disposed in a location conducive to maintaining propagation of said at least two light wave portions through said slab during a slab rotation.

10. A device of claim 9, wherein said slab comprises at least one slab characteristic selected from a group of characteristics consisting essentially of thin, flat, and transparent.

11. A device of claim 9, wherein said slab comprises an anti-reflection (AR) coating.

12. A device of claim 1, wherein said means for performing wave front division comprises a wave guide having at least two phase retardation regions, each region of said at least two phase retardation regions having a distinct refractive index, each wave portion of said at least two light wave portions propagate through each region, and wherein said means for interfering comprises an exit wave guide.

13. A device of claim 12, wherein said exit wave guide comprises a single mode wave guide.

14. A device of claim 1, wherein said means for performing wave front division comprises at least two etalons.

15. A device of claim 14, wherein said at least two etalons have a same refractive index.

16. A device of claim 1, wherein said means for performing wave front division comprises:
(a) a half-wave generator disposed in said light path for transforming said light wave into two light wave portions, and
(b) wherein said means for interfering comprises a lens, a gain chip and a 110 partial reflector.

17. A device of claim 16, wherein said gain chip comprises a wave guide having at least two regions, each region of said at least two regions having a distinct refractive index, each said light wave portion experiencing said distinct refractive index.

18. A device of claim 16, wherein said gain chip further comprises at least one feature selected from a group of features consisting essentially of a rear high reflection (HR) coating and a front low anti-reflection (AR) coating.

19. A device of claim 16, wherein said half-wave generator further comprises at least one feature selected from a group of features consisting essentially of a rear high reflection (HR) coating and a front low anti-reflection (AR) coating.

20. A device of claim 1, wherein said means for wave front division is selected from a group of media consisting essentially of a vacuum, a gas, a colloid, or a liquid through which said at least two light wave portions are capable of being propagated.

21. A device of claim 1 comprising optical components in an optical interferometer.

22. A device of claim 1 comprising optical components in an interferometric modulator.

23. A device of claim 1 comprising optical components in an interferometric filter.

24. A device of claim 1 comprising optical components of an interferometric laser.

25. A device of claim 24 wherein:
said means for performing wave front division comprises a half-wave generator disposed in said light path for transforming said light wave into said at least two wave portions, and wherein said means for interfering comprises a lens, a gain chip and a partial reflector.

26. A device of claim 24 wherein: said interferometric laser comprises said means for simultaneously performing wave front division and phase retardation being disposed in a laser cavity of said interferometer laser.

27. A method for generating an interference spectrum of a light wave, said method comprising the steps of:
A. providing an optical interference device, said interference device comprising:
(a) means for simultaneously performing and producing different phase retardation on said light wave and generating at least two wave portions of said light wave; and
(b) a means for interfering said at least two wave portion and generating said single interference spectrum;
B. performing wave front division on a light wave using said means for performing wave front division and simultaneously generating said at least two wave portions; and
C. performing interference of said two wave portions using said means for interfering and creating said interference spectrum.

28. The method of claim 27, wherein said device comprises a tunable interference device, said device being tunable by modifying at least one parameter selected from a group of parameters associated with said means for performing wave front division and said means for interfering, said group of parameters consisting essentially of a refraction index, a distance traversed by each said at least two light wave portions, a location, an orientation, an environment, and a thickness.

29. The method of claim 27, wherein said device comprises a fixed wavelength type of interference device.

30. The method of claim 27, wherein said means for performing wave front division comprises at least two media, each medium of said at least two media having a distinct index of refraction through which said light wave propagates, said at least two media being disposed such that one of said at least two wave portions propagates through one medium, while another one of said at least two wave portions propagates through another medium of said at least two media.

31. The method of claim 27, wherein said means for interfering comprises at least one lens for focusing said at least two light wave portions.

32. The method of claim 27, wherein said at least two light wave portions propagate by a manner selected from a propagation group consisting essentially of simultaneous propagation and sequential propagation.

33. The method of claim 27, wherein said means for interfering is further disposed aft of said means for performing wave front division.

34. The method of claim 27, wherein said means for performing wave front division comprises at least two reflectors for generating said at least two light wave portions, and wherein each reflector, of said at least two reflectors, is disposed at a distinct location such that each said reflector reflects respective portions of light wave.

35. The method of claim 27 wherein said means for performing wave front division comprises a slab, said slab being rotatable about an axis for facilitating tuning of said interference spectrum, said axis being disposed in a location conducive to maintaining propagation of said at least two light wave portions through said slab during a slab rotation.

36. The method of claim 35, wherein said slab comprises at least one slab characteristic selected from a group of characteristics consisting essentially of thin, flat, and transparent.

37. The method of claim 35, wherein said slab comprises an anti-reflection (AR) coating.

38. The method of claim 27, wherein said means for performing wave front division comprises a wave guide having at least two phase retardation regions, each region of said at least two phase retardation regions having a distinct refractive index, each wave portion of said at least two light wave portions propagate through each region, and wherein said means for interfering comprises an exit wave guide.

39. The method of claim 38, wherein said exit wave guide comprises a single mode wave guide.

40. The method of claim 27, wherein said means for performing wave front division comprises at least two etalons.

41. The method of claim 40, wherein said at least two etalons have a same refractive index.

42. The method of claim 27 wherein said means for performing wave front division comprises:
a half-wave generator disposed in said light path for transforming said light wave into two light wave portions; and
wherein said means for interfering comprises a lens, a gain chip and a partial reflector disposed in said light path between said gain chip and said half-wave generator, for collimating said light wave from the gain chip.

43. The method of claim 42, wherein said gain chip comprises a wave guide having at least two regions, each region of said at least two regions having a distinct refractive index, each said light wave portion experiencing said distinct refractive index.

44. The method of claim 42, wherein said gain chip further comprises at least one feature selected from a group of features consisting essentially of a rear high reflection (HR) coating and a front low anti-reflection (AR) coating.

45. The method of claim 42, wherein said half-wave generator further comprises at least one feature selected from a group of features consisting essentially of a rear high reflection (HR) coating and a front low anti-reflection (AR) coating.

46. The method of claim 27, wherein said means for wave front division is selected from a group of media consisting essentially of a vacuum, a gas, a colloid, or a liquid through which said at least two light wave portions are capable of being propagated.

46. The method of claim 27 wherein said interference device comprise optical components in an optical interferometer.

48. The method of claim 27 wherein said interference device comprise optical components in an interferometric modulator

49. The method of claim 27 wherein said interference device comprise optical components in an interferometric filter.

50. The method of claim 27 wherein said interference device comprise optical components of an interferometric laser.

51. The method of claim 50 wherein:
said means for performing wave front division comprises a half-wave generator disposed in said light path for transforming said light wave into said at least two wave portions, and wherein said means for interfering comprises a lens, a gain chip and a partial reflector.

52. The method of claim 50 wherein:
said interferometric laser comprises said means for simultaneously performing wave front division and phase retardation being disposed in a laser cavity of said interferometer laser

53. An interferometric laser apparatus, said apparatus comprising:
a. a means for simultaneously performing and producing different phase retardation on said light wave and generating at least two wave portions of said light wave; and
b. means for interfering said at least two wave portion and generating said single interference spectrum.

54. The laser apparatus of claim 53, wherein said laser apparatus comprises a tunable interference device, said interference device being tunable by modifying at least one parameter selected from a group of parameters associated with said means for performing wave front division and said means for interfering, said group of parameters consisting essentially of a refraction index, a distance traversed by each said at least two light wave portions, a location, an orientation, an environment, and a thickness.

55. The laser apparatus of claim 53, wherein said interferometric laser comprises a fixed wavelengh type of interferometric laser.

56. The laser apparatus of claim 53, wherein said means for performing wave front division comprises at least two media, each medium of said at least two media having a distinct index of refraction through which said light wave propagates, said at least two media being disposed such that one of said at least two wave portions propagates through one medium, while another one of said at least two wave portions propagates through another medium of said at least two media.
